(19) United States
(12) Patent Application Publication
(10) Pub. No.: US 2026/0158704 A1
(43) Pub. Date: Jun. 11, 2026

(54) CUTTING METHOD

(71) Applicant: Giorgio DONATONI, Cavaion Veronese (VR) (IT)

(72) Inventor: Giorgio DONATONI, Cavaion Veronese (VR) (IT)

(21) Appl. No.: 18/707,261

(22) PCT Filed: Dec. 20, 2022
(86) PCT No.: PCT/IB2022/062523

§ 371 Date: May 3, 2024

(30) Foreign Application Priority Data
Dec. 28, 2021 (IT) 102021000032804

(51) Int. Cl. B28D 1/04

(52) U.S. Cl. CPC B28D 1/048

(57) ABSTRACT

A method for cutting slabs using a cutting head having a frame that supports first and second blades, aligned substantially vertical, and having centers spaced apart, the frame being hinged to the carriage by a horizontal pin thereby allowing oscillation of the frame and change the blade height and cutting depth.

The method includes:
first frame inclination with respect to a first slab to be cut so that the first blade is lower than the second;
pre-cutting the first slab using the first blade;
second frame inclination with respect to first slab so that the first blade is higher than the second;
cutting the first slab using the second blade;
third frame inclination with respect to first slab so that the first blade is higher than the second by a third height, preventing the first blade from interacting with a second slab adjacent to the first when cutting the first.

### FIELD OF THE INVENTION

The present invention generally relates to the technical field of machining stone and/or ceramic materials and particularly relates to a method for cutting slabs using a cutting head.

### BACKGROUND ART

In the industry for machining slabs made of stone and/or ceramic material, there has been long known to use machine tools comprising a gantry structure suitable to delimit a work area and at least one horizontal beam on which there is slidably mounted a head for processing the slabs.

The machining operations carried out with such machines are for example cutting, smoothing, contouring, chamfering or the like, and they may require handling, loading/unloading and/or transfer of the products being machined from one area to another of the work area.

Generally, in the processes for cutting the slabs, the machine tool comprises a carriage slidable on the main beam and a cutting head movable above the slab with an electro-spindle to which there is rotatably associated a blade-equipped cutting tool.

Typically, when the cutting head is configured to carry out discontinuous or staggered cuts on two or more adjacent slabs along a horizontal axis, the second slab is spaced from the first slab by a value proportional to the diameter of the blade, so as to prevent the blade from interacting with the transversal peripheral edge of the second slab arranged adjacent to the first slab after cutting the first slab.

However, when the cutting head supports at least one first and one second blade which are substantially vertical and aligned, and having respective centres spaced by a predetermined distance, the distance between the first and the second slab is excessive, resulting in the increase of machining times and decrease in the number of slabs arranged adjacent to each other during machining.

In order to at least partially overcome this drawback, there have been developed cutting apparatuses and methods adapted to vary the height of each blade.

WO2017002035 discloses an apparatus and a method for cutting porcelain slabs or the like, which provides for a cutting head arranged above a plane for supporting a slab.

The head is provided with a plurality of rotary tools associated with a carriage movable along a horizontal axis and means for the vertical movement of the tools independently from each other.

The method for cutting a slab using such apparatus provides a first step in which the carriage is moved towards the slab to be machined with only one first tool lowered so as to interact with the slab.

The first tool starts to engrave the slab and, subsequently, the second tool is lowered upon exceeding the entry point on the slab. Lastly, the first tool is raised before it exits from the final part of the slab.

EP3842172 discloses an apparatus provided with a cutting head equipped with a first and a second disc-shaped blade aligned with respect to each other along a cutting direction and arranged above a work plane suitable to support at least one slab.

Furthermore, the cutting head comprises means for the vertical movement of each blade to lift each blade with respect to the slab when the blade finishes to cut the slab.

A first known drawback of such solutions lies in the fact that the means for the vertical movement act independently on each blade of the cutting head with ensuing increase in the costs for manufacturing the cutting head.

Still, another drawback of such solutions lies in the fact that the means for vertically moving the blades do not allow to reduce the distance between the slabs to be cut.

### TECHNICAL PROBLEM

In the light of the prior art, the object of the present invention is to solve the technical problem by providing a cutting head which allows to machine several slabs arranged adjacent to each other in which the blades do not damage the subsequent slab after cutting, and at the same time it allows to reduce the distance between the slabs.

### SUMMARY OF THE INVENTION

The object of the present invention is to solve the aforementioned problem by providing a method for cutting slabs made of stone and/or ceramic material which is highly effective and cost-effective.

A particular object of the present invention is to provide a cutting method of the type indicated above which allows to reduce the distance between two slabs arranged adjacent to each other when cutting them.

Another particular object of the present invention is to provide a cutting method of the type indicated above which allows to carry out discontinuous or staggered cuts on one or more adjacent slabs along a horizontal axis, preventing the blade from interacting with the transversal peripheral edge of a second slab arranged adjacent to the first slab after cutting the first slab.

A further object of the present invention is to provide a cutting method of the type indicated above which makes the operations for pre-cutting and cutting two adjacent slabs particularly quick and simple.

Another object of the present invention is to provide a cutting method of the type indicated above which allows to carry out the pre-cutting and cutting of the slab in a single phase.

A further object of the present invention is to provide a cutting method of the type indicated above which allow to reduce downtime between the discontinuous cut of one slab and the subsequent one, increasing the overall productivity.

A further object of the present invention is to provide a cutting method of the type indicated above which allows to reduce the overall set-up and installation times.

A further object of the present invention is to provide a cutting method of the type indicated above which allows to adjust the relative height between the blades.

The objects mentioned above and others which will be more apparent hereinafter, are achieved by a cutting method according to claim 1.

The method provides the cutting of slabs made of stone and/or ceramic material using a cutting head having a tool-holder frame mounted on a carriage movable above the slabs along three cartesian axes, wherein the frame supports at least one first and one second blade which are substantially vertical and aligned, and having respective centres spaced apart by a predetermined distance.

The frame is hinged to the carriage by means of a substantially horizontal pin so as to allow the oscillation of the frame and vary the relative height of the blades and the cutting depth thereof.

The method comprises the following steps a) first inclination of the frame by a first predetermined angle with respect to a first slab to be cut so that the first blade is lower than the second blade by a first relative height, b) pre-cutting the first slab using the first blade, c) second inclination of the frame by a second predetermined angle with respect to the first slab so that the first blade is higher than the second blade by a second relative height, d) cutting the first slab using the second blade and e) third inclination of the frame by a third predetermined angle with respect to first slab so that the first blade is higher than the second blade by a third relative height greater than the second relative height so as to prevent the first blade from interacting with a second slab arranged adjacent to the first slab when cutting the first slab in step d).

Advantageous embodiments of the invention are attained according to the dependent claims.

### BRIEF DESCRIPTION OF THE DRAWINGS

Further characteristics and advantages of the invention will be more apparent in the light of the detailed description of a preferred but not exclusive embodiment of a cutting method like the one mentioned above, shown by way of non-limiting example with reference to the drawings below, wherein:

FIG. 1 is a schematic perspective view of a multi-axial machine on which there is mounted at least one cutting head of the method according to the invention;

FIG. 2 is an enlarged lateral view of the cutting head of FIG. 1;

FIG. 3 is a top view of several slabs arranged adjacent to each other to be cut by means of the method according to the invention;

FIG. 4 is a schematic lateral view of a cutting method according to the state-of-the-art, with an excessive distance between the slabs;

FIG. 5 shows the steps of the method according to the invention;

FIGS. 6 to 12 are schematic lateral views of steps a)-e) of the method of FIG. 5.

### DETAILED DESCRIPTION OF A PREFERRED EMBODIMENT

With particular reference to the figures, there is shown a method for cutting slabs L made of stone and/or ceramic material using a cutting head, indicated in its entirety with the reference numeral 1 and shown in FIG. 2.

The cutting head 1 may be applied to a multi-axial machine tool 2 for cutting or shaping also slabs L made of stone material, such as stone, marble, granite, stony or concrete conglomerates, and to obtain a plurality of suitably shaped portions L′, L″.

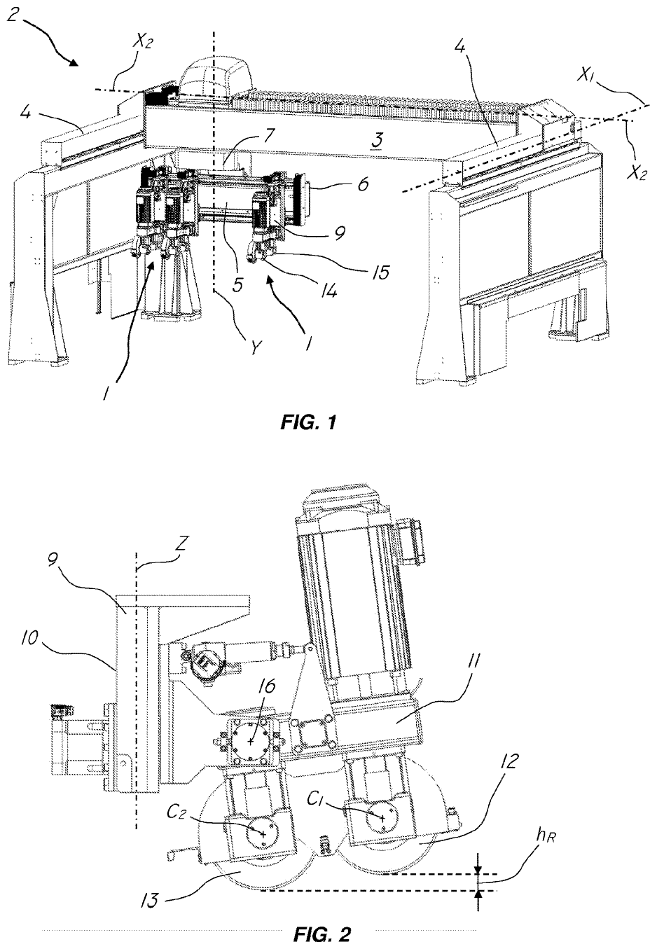

As better shown in FIG. 1, the multi-axial machine tool 2 may comprise at least one substantially horizontal main beam 3 movable along first longitudinal guide means 4 anchored to the ground, as described in the patent application EP2983879 owned by the Applicant, whose contents are fully included in the present application.

The machine 2 comprises at least one substantially horizontal secondary beam 5 operatively associated with the main beam 3, and means for the discontinuous advancement of the slabs L for loading/unloading them, not shown in the figures.

Advantageously, the machine 2 may comprise one or more cutting heads 1 mounted on the secondary beam 5 and slidably movable along second guide means 6 associated with the secondary beam 5 to carry out cuts along directions parallel to a longitudinal cutting direction D in a single phase, as described below.

The secondary beam 5 may be mounted below the main beam 3 and can be rotatably coupled to the latter using third guide means 7 to rotate around a substantially vertical axis Y and to vary the direction of the common cutting direction D.

Furthermore, the machine tool 2 may be arranged above a table for supporting the slabs L being machined having a fixed or movable work plane 8.

In a per se known manner, the slabs L may comprise a substantially flat upper surface L_{A} facing upwards and facing the cutting head 1, a substantially flat lower surface L_{B} resting on the work plane 8, and a maximum thickness s having predetermined and substantially constant dimensions.

As shown in FIG. 2, the cutting head 1 comprises a carriage 9 movable above the slabs L along a first transversal axis X₁ and along a second longitudinal axis X₂ by means of respective first 4 and second guide means 6.

Furthermore, the carriage 9 comprises movement means 10 which are substantially vertical and can be coupled to the main beam 3, or to the secondary beam 5, of the machine tool 2 on which the cutting head 1 is mounted so as to move it along a vertical axis Z. Therefore, the carriage 9 is movable above the slabs L along the three cartesian axes X₁, X₂, Z.

Advantageously, the cutting head 1 comprises a tool-holder frame 11 mounted on the carriage 9 and that supports at least one first 12 and one second blade 13 which are substantially vertical and mutually aligned along the longitudinal cutting direction D, and having respective centres C₁, C₂ for coupling to respective electro-spindles 14, 15 spaced apart by a predetermined distance V.

Preferably, the first 12 and the second blade 13 have substantially equal diameters.

Furthermore, the frame 11 is hinged to the carriage 9 by means of a substantially horizontal pin 16 so as to allow the oscillation of the frame 11 and vary the relative height h_{R} of the blades 12, 13 and the respective cutting depth h₁, h₂ thereof.

In a preferred embodiment of the invention, schematically shown in figures, the pin 16 may be positioned in proximity of a first longitudinal end of the frame 11 and above the second blade 13 so that the latter has a substantially constant height position in response to the oscillation of the frame 11, therefore solely varying the height of the first blade 12.

In an alternative embodiment, not shown in the figures, the pin 16 may be in intermediate position with respect to the longitudinal ends of the frame 11, so that such intermediate position has a substantially constant height position in response to the oscillation of the frame 11.

Therefore, the first cutting blade 12 is configured to carry out a pre-cutting T₁ in the slab L having a pre-cutting depth h₁ with depth which can be adjusted and smaller than the thickness s of the slab L, while the second cutting blade 13 is configured to carry out the final cutting T₂ of the slab L and therefore with a cutting depth h₂ with depth which can be adjusted and equal to or greater than the thickness s of the slab L.

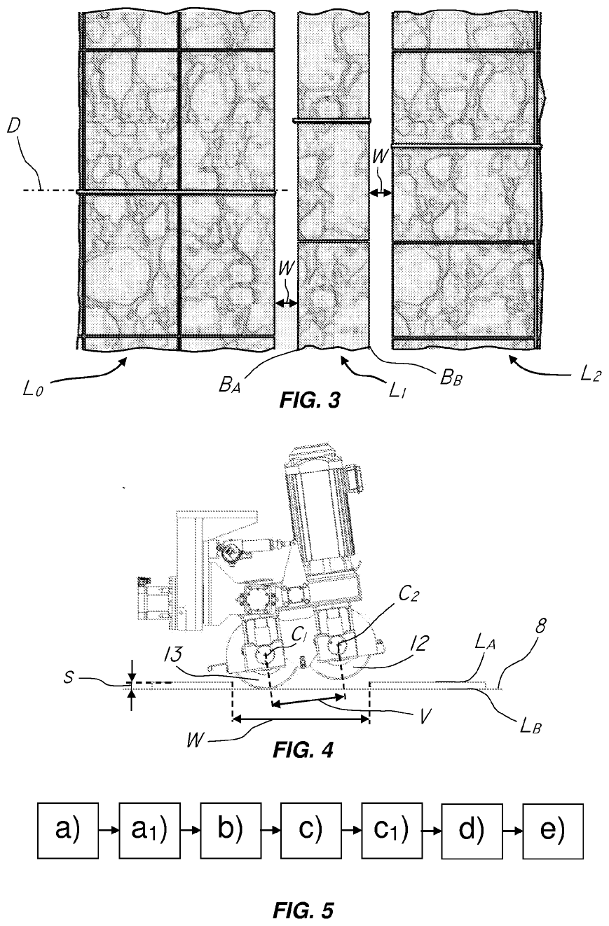

Furthermore, the slabs L may be arranged along the work plane 8 side by side and transversely spaced apart by a predetermined value W, so as to allow the discontinuous cutting thereof, or carry out the horizontally staggered cuts, as shown in FIG. 3.

As better shown in FIGS. 5-12, the cutting method according to the invention is carried out by the cutting head 1 so as to prevent the distance W between the slabs L from being excessive. Such excessive distance W is schematically shown in FIG. 4.

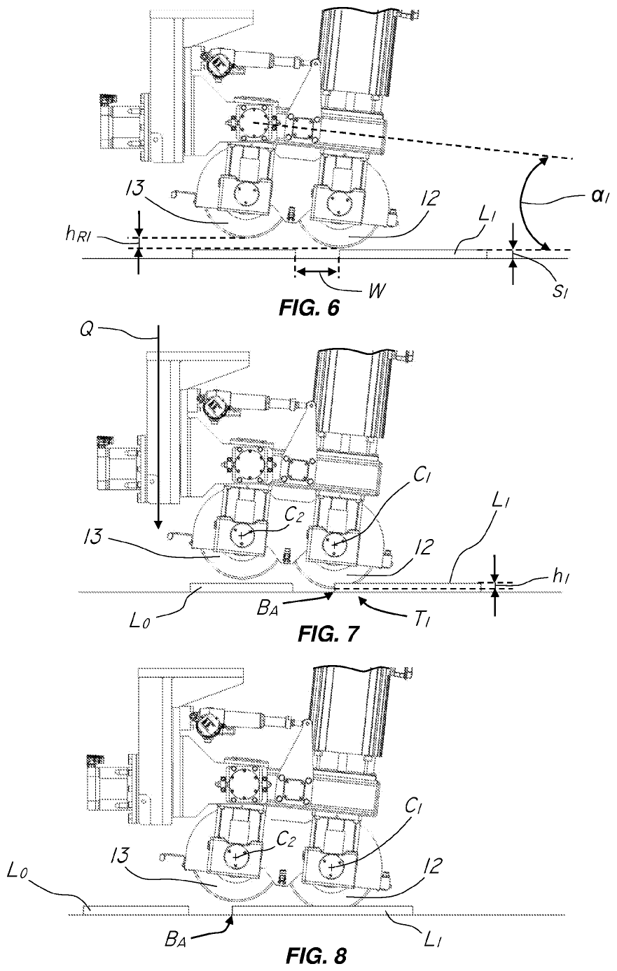

Therefore, the method according to the invention comprises a first step a) of first inclination of the frame 11 by a first predetermined angle α₁ with respect to a first slab L₁ to be cut so that the first blade 12 is lower than the second blade 13 by a first relative height h_{R1}, as shown in FIG. 6.

Subsequently, the method provides a step b) of pre-cutting the first slab L₁ using the first blade 12, as shown in FIGS. 7 and 8.

Furthermore, before the step b) of pre-cutting there is provided a step a₁) of first lowering of the carriage 9 with respect to the work plane 8 so as to allow the first blade 12 to interact with the first slab L₁ and carry out the pre-cutting T₁, as shown in FIG. 7.

Preferably, the first lowering of the carriage 9 occurs in a substantially vertical direction Q.

Opportunely, the step a₁) of first lowering is carried out when the centre C₁ of the first blade 12 is positioned at the first transversal peripheral edge B_{A} of the first slab L₁.

By way of non-limiting example, during step b) of pre-cutting, the first slab L₁ is pre-cut by the first blade 12 for a pre-cutting depth h₁ which corresponds to 50% of the thickness s₁ of the first slab L₁.

Furthermore, during step b) of pre-cutting, the second blade 13 does not interact with the first slab L₁ and does not even interact with a possible slab L₀ positioned preceding the first slab L₁ along the cutting direction D.

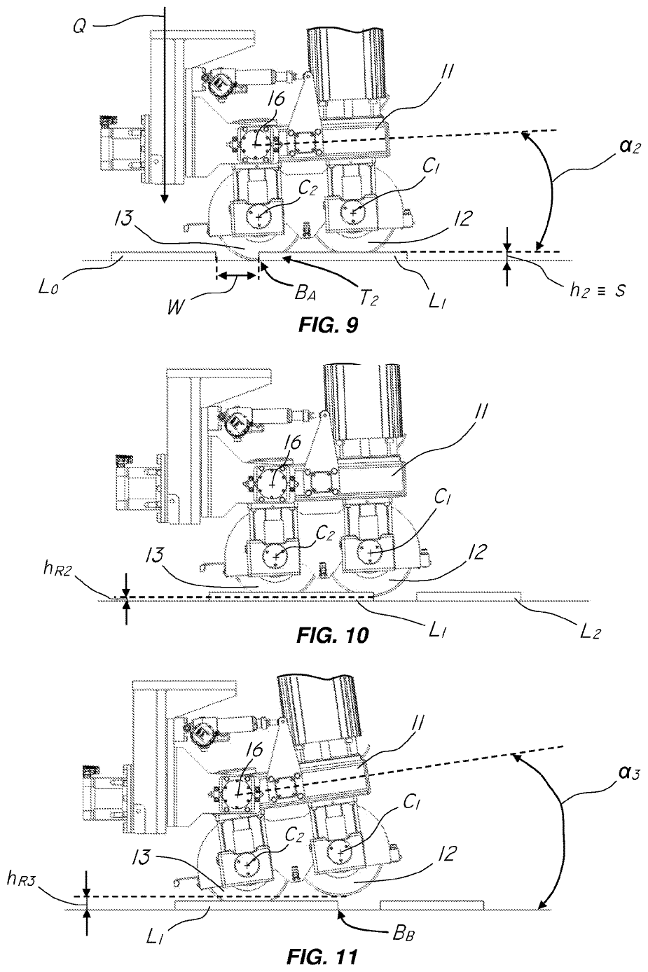

Subsequently, there are provided a step c) of second inclination of the frame 11 by a second predetermined angle α₂ with respect to the first slab L₁ so that the first blade 12 is higher than the second blade 13 by a second relative height h_{R2}, and a step d) of cutting the first slab L₁ using the second blade 13, as shown respectively in FIGS. 9 and 10.

Suitably, the step c) of second inclination is at least partially carried out during step b) of pre-cutting so that the movement of the cutting head 1 along the common cutting direction D is not interrupted.

Furthermore, during said step c) of second inclination there is provided a step c₁) of second lowering of the carriage 9 with respect to the work plane 8 so as to allow the second blade 13 to interact with the first slab L₁ maintaining constant the pre-cutting depth h₁ of the first blade 12.

Preferably, the second lowering of the carriage 9 occurs in a substantially vertical direction Q.

Advantageously, the steps c) of second inclination and c₁) of second lowering are carried out at the same time and when the centre C₂ of the second blade 13 is positioned at the first transversal peripheral edge B_{A} of the first slab L₁.

By way of non-limiting example, during step d) of cutting, the first slab L₁ is cut by the second blade 13 for a cutting depth h₂ which corresponds to 100% of the thickness s₁ of the first slab L₁.

Lastly, the method according to the invention provides a step e) of third inclination of the frame 11 by a third predetermined angle as with respect to the first slab L₁ so that the first blade 12 is higher than the second blade 13 by a third relative height h_{R3} greater than the second relative height h_{R2}.

Conveniently, the step e) of third inclination is at least partially carried out during said step d) of cutting and when the centre C₁ of the first blade 12 is positioned at the second transversal peripheral edge B_{B} of the first slab L₁.

Furthermore, during the step e) of third inclination, the second blade 13 interacts with the first slab L₁ maintaining constant the cutting depth h₂ of the second blade 13.

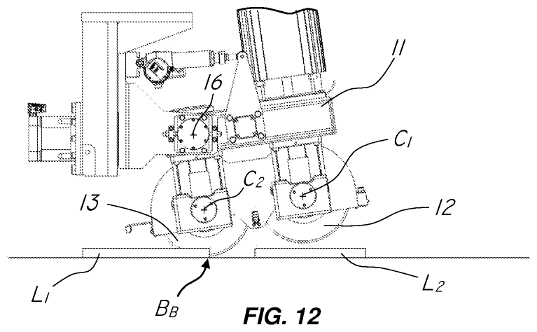

Following the step e) of third inclination, the cutting of the first slab L₁ during the step d) may end when the centre C₂ of the second blade 13 is positioned at the second transversal peripheral edge B_{B} of the first slab L₁, as better shown in FIG. 12.

Therefore, step e) allows to prevent the first blade 12 from interacting with a second slab L₂ arranged adjacent to the first slab L₁ when cutting the first slab L₁ in step d).

The first h_{R1}, second h_{R2} and third relative height h_{R3} are calculated using the formula h_{R}=V×sinα±K, wherein K is a predetermined constant relating to the thickness s₁, S₂ of the slabs L₁, L₂ being processed.

More precisely, the predetermined constant K is a numerical value comprised between 0 and the sum between the thickness s of the slab Kₛ, wherein Kₛ is a predetermined safety coefficient with value greater than 0 and calculated so as to prevent the blades 12, 13 from interacting with the slabs L being processed.

More precisely:
h_{R1}=V×sinα₁±K₀, wherein 0<K₀<S₀+Kₛ, wherein s₀ is the thickness of the slab L₀ possibly preceding the first slab L₁;
h_{R2}=V×sinα₂±K₁, wherein 0<K₁<s₁;
h_{R3}=V×sinα₃±K₂, wherein 0<K₂<s₂+Kₛ, wherein s₂ is the thickness of the second slab L₂.

It is clear that steps a)-e) of the method according to the invention, and more precisely the values of the predetermined angles α₁, α₂, α3 respectively of steps a), c) and e) for inclining the frame 11, allow to carry out discontinuous or staggered cuts of two or more adjacent slabs along a horizontal axis, preventing the first blade 12 from interacting with the transversal peripheral edge B_{A} of a second slab L₂ after cutting the first slab L₁ by means of the second blade 13.

At the same time, the method for cutting slabs arranged adjacent to each other using a cutting head 1 of the type described above, allows to space the first slab L₁ from the second slab L₂ by the same distance W that would be obtained by cutting the slabs L₁, L₂ using a cutting head provided with only one cutting blade.

In the light of the above it is clear that the cutting method according to the invention achieves the pre-established objects and in particular it allows to reduce the distance between two slabs arranged adjacent to each other when cutting them.

The method according to the invention is susceptible to numerous modifications and variants all falling within the inventive concept outlined in the attached claims.

Although the method has been described with particular reference to the attached figures, the reference numerals used in the description and in the claims are meant for improving the intelligibility of the invention and do not limit the claimed scope of protection in any manner whatsoever.

Throughout the description, reference to “an embodiment” or “the embodiment” or “some embodiments” indicate that a particular characteristic, structure or element described is comprised in at least one embodiment of the object of the present invention.

Furthermore, the particular characteristics, structures or elements may be combined in any appropriate fashion in one or more embodiments.

### INDUSTRIAL APPLICABILITY

The present invention is industrially applicable because it can be produced in industrial scale by industries belonging to the field of machining stone and/or ceramic materials.

1. A method of cutting slabs (L), made of stone and/or ceramic material, with a cutting head (1) having a tool-holder frame (11) mounted on a carriage (9) movable above the slabs (L), wherein said frame (11) supports, at least, one first blade (12) and one second blade (13) which are substantially vertical and mutually aligned along a longitudinal cutting direction (D) and have respective centers (C₁, C₂) spaced apart by a predetermined distance (V), said frame (11) being hinged to said carriage (9) by means of a substantially horizontal pin (16) so as to allow the oscillation of said frame (11) and vary a relative height (h_{R}) of said blades (12, 13) and a respective cutting depth (h₁, h₂) thereof, the method comprising:
a) first inclination of said frame (11) by a first predetermined angle (α₁) with respect to a first slab (L₁) to be cut so that said first blade (12) is lower than said second blade (13) by a first relative height (h_{R1});
b) pre-cutting the first slab (L₁) using said first blade (12);
c) second inclination of said frame (11) by a second predetermined angle (α₂) with respect to the first slab (L₁) so that said first blade (12) is higher than said second blade (13) by a second relative height (h_{R2});
d) cutting the first slab (L₁) using said second blade (13); and
e) third inclination of said frame (11) by a third predetermined angle (α₃) with respect to the first slab (L₁) so that said first blade (12) is higher than said second blade (13) by a third relative height (h_{R3}) greater than said second relative height (h_{R2}) so as to prevent said first blade (12) from interacting with a second slab (L₂) adjacent to the first slab (L₁).

2. The method as claimed in claim 1, wherein said first (h_{R1}), second (h_{R2}) and third relative heights (h_{R3}) are calculated using the formula h_{R}=V×sinα±K, wherein K is a predetermined constant relating to a thickness (S₁, S₂) of the slabs (L₁, L₂) being processed.

3. The method as claimed in claim 2, wherein said predetermined constant (K) is a numerical value comprised between 0 and s+Kₛ, wherein Kₛ is a predetermined safety coefficient with value greater than 0 so as to prevent said first (12) and second blade (13) from interacting with the slabs (L₁, L₂) being processed.

4. The method as claimed in claim 1, further comprising first lowering of said carriage (9) with respect to the work plane (8) on which the slabs (L₁, L₂) are arranged to allow said first blade (12) to interact with the first slab (L₁) before said pre-cutting.

5. The method as claimed in claim 4, wherein said first lowering is carried out when the center (C₁) of said first blade (12) is positioned at the first transversal peripheral edge (B_{A}) of the first slab (L₁).

6. The method as claimed in claim 1, wherein said second inclination is carried out at least partially during said pre-cutting.

7. The method as claimed in claim 1, wherein further comprising, during said second inclination, a second lowering of said carriage (9) with respect to the work plane (8) on which the slabs (L₁, L₂) are arranged so as to allow said second blade (13) to interact with the first slab (L₁) maintaining the pre-cutting depth (h₁) of said first blade (12) constant.

8. The method as claimed in claim 6, wherein said second inclination and said second lowering are carried out at the same time and when the center (C₂) of said second blade (13) is positioned at the first transversal peripheral edge (B_{A}) of the first slab (L₁).

9. The method as claimed in claim 1, wherein said third inclination is carried out at least partially during said cutting.

10. The method as claimed in claim 1, wherein said third inclination is carried out when the center (C₁) of said first blade (12) is positioned at the second transversal peripheral edge (B_{B}) of the first slab (L₁).

11. The method as claimed in claim 1, wherein during said third inclination, said second blade (13) interacts with the first slab (L₁) maintaining constant the cutting depth (h₂) of said second blade (13).

12. The method as claimed in claim 1, wherein said first (12) and second blade (13) have substantially equal diameters.
